(19) United States
(12) Patent Application Publication
(10) Pub. No.: US 2026/0359385 A1
(43) Pub. Date: Nov. 12, 2026

(54) ORTHOGONAL LOW RANK EMBEDDING STABILIZATION

(71) Applicant: NETFLIX, INC., Los Gatos, CA (US)

(72) Inventors: Kevin J. ZIELNICKI, San Francisco, CA (US); Ko-Jen HSIAO, San Jose, CA (US)

(21) Appl. No.: 19/323,818

(22) Filed: Sep. 9, 2025

Related U.S. Application Data
(60) Provisional application No. 63/801,726, filed on May 7, 2025.

(51) Int. Cl. G06F 17/16

(52) U.S. Cl. CPC G06F 17/16

(57) ABSTRACT

Orthogonal low rank embedding stabilization includes receiving a new user embedding matrix, receiving a new item embedding matrix, generating a transformed user embedding matrix and a transformed item embedding matrix from the new user embedding matrix and the new item embedding matrix, generating a transformation that maps the transformed item embedding matrix to an embedding space of a previous version of the item embedding matrix, generating a stabilized user embedding matrix based on the transformation, the new user embedding matrix, and the transformed user embedding matrix, and generating a stabilized item embedding matrix based on the transformation, the new item embedding matrix, and the transformed item embedding matrix.

### CROSS-REFERENCE TO RELATED APPLICATIONS

This application claims priority benefit of the United States Provisional Patent Application titled, “TECHNIQUES FOR IMPLEMENTING ORTHOGONAL LOW RANK EMBEDDING STABILIZATION,” filed on May 7, 2025, and having Ser. No. 63/801,726. The subject matter of this related application is hereby incorporated by reference.

### BACKGROUND OF THE INVENTION

### Field of the Invention

Embodiments of the present disclosure relate generally to computer science and machine learning and, more specifically, to orthogonal low rank embedding stabilization.

### Description of the Related Art

A recommendation system is a machine learning algorithm that uses collected data of past user behavior to provide personalized recommendations to a user. Recommendation systems are widely used in applications such as audio or video streaming services, social media platforms, and e-commerce. For example, recommendation systems are used to suggest movies and TV shows, and for matching customers with products and services while online shopping.

Recommendation systems use one of two main techniques: content filtering or collaborative filtering. Content filtering techniques use the attributes or features of an item to recommend similar items to a user. For example, on a video streaming service, a content filtering algorithm may recommend a movie of a similar genre or with a similar cast to a movie previously viewed by a user. Collaborative filtering techniques analyze the information provided by many users (e.g. star ratings on movies or products purchased) across many items to provide recommendations to a user with similar preferences. For example, on an e-commerce platform, a collaborative filtering algorithm may recommend a product based on the purchases of users with similar shopping histories.

One drawback of the current recommendation system approaches, however, is that these techniques rely on data which needs to be constantly updated to include new users and new items as well as continued interactions of users with items. Retraining a recommendation system model from scratch daily can take a significant amount of time and consume a large amount of computing resources. As a recommendation system model grows in complexity, the computational costs associated with deploying a recommendation system model for various downstream applications also increase.

Another drawback is that a recommendation system requires a significant amount of data about a user or item to make accurate recommendations. Accordingly, many recommendation system models rely on internal embeddings to capture the relationship between users and items using a low-dimensional representation. However, each time the recommendation system model is retrained to add a new user or a new item, the embedding space changes. In addition, with each retraining any downstream applications that rely on the embedding must also undergo retraining to use the retrained embeddings.

As the foregoing illustrates, what is needed in the art are more effective techniques for recommendation systems.

### SUMMARY

According to some embodiments, a computer-implemented method for stabilizing embeddings includes receiving a new user embedding matrix, receiving a new item embedding matrix, generating a transformed user embedding matrix and a transformed item embedding matrix from the new user embedding matrix and the new item embedding matrix, generating a transformation that maps the transformed item embedding matrix to an embedding space of a previous version of the item embedding matrix, generating a stabilized user embedding matrix based on the transformation, the new user embedding matrix, and the transformed user embedding matrix, and generating a stabilized item embedding matrix based on the transformation, the new item embedding matrix, and the transformed item embedding matrix.

Further embodiments provide, among other things, non-transitory computer-readable storage media storing instructions and systems configured to implement the method set forth above.

At least one technical advantage of the disclosed techniques relative to the prior art is that, with the disclosed techniques, a standardized embedding space for user and item embeddings across each model training run is established. Another technical advantage of the disclosed techniques is that, once a standardized embedding space has been established based on initial training for the embeddings, future embeddings still use the same standardized embedding space. As a result, with the disclosed techniques, each time the embeddings are updated, the downstream applications that rely on the embeddings don't have to be retrained even though the embeddings have been updated, which significantly reduces the computational resources needed to take advantage of updated embeddings in the downstream applications. These technical advantages represent one or more technological improvements over prior art approaches. Aspects of the subject matter described herein are set out in the following numbered clauses.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a network infrastructure used to distribute content to content servers and endpoint devices, according to various embodiments;

FIG. 2 is a block diagram of a content server that may be implemented in conjunction with the network infrastructure of FIG. 1, according to various embodiments;

FIG. 3 is a block diagram of a control server that may be implemented in conjunction with the network infrastructure of FIG. 1, according to various embodiments;

FIG. 4 is a block diagram of an endpoint device that may be implemented in conjunction with the network infrastructure of FIG. 1, according to various embodiments;

FIG. 5 is a block diagram of a computer-based system according to various embodiments;

FIG. 6 is a more detailed illustration of the embedding stabilizer of FIG. 5, according to various embodiments;

FIG. 7 is a more detailed illustration of the recommendation application of FIG. 5, according to various embodiments;

FIG. 8 sets forth a flow diagram of method steps for generating stabilized item embeddings and stabilized user embeddings of FIG. 5, according to various embodiments; and

FIG. 9 sets forth a flow diagram of method steps for generating recommendations, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

As described, a recommendation system is a machine learning algorithm that uses collected data of past user behavior to provide personalized recommendations to a user. However, recommendation systems rely on data which needs to be constantly updated to include new users and new items as well as continued interactions of users with items to make accurate recommendations. Accordingly, many recommendation system models rely on internal embeddings to capture the relationship between users and items using a low-dimensional representation. However, each time the recommendation system model is retrained to add a new user or a new item, the embedding space changes. Using the new embedding space can lead to inaccurate recommendations, therefore, the embedding must also be retrained. In addition, with each retraining any downstream applications that rely on the embedding must also undergo retraining to use the retrained embeddings.

The disclosed techniques set forth a comprehensive system for generating stabilized user embeddings and stabilized item embeddings. First, a user-item interaction matrix is approximated by the product of an item embedding matrix and a user embedding matrix. Next, a first matrix with orthogonal columns and a first upper triangular matrix is generated from the item embedding matrix using QR-decomposition. Then, a second matrix with orthogonal columns and a second upper triangular matrix is generated from the user embedding matrix using QR-factorization. A singular value decomposition is performed on the first upper triangular matrix multiplied with the transpose of the second upper triangular matrix to generate the low-rank singular value decomposition for the product of the item matrix and the user matrix. The orthogonal matrices and diagonal matrix resulting from the singular value decomposition are then used to generate an item transformation matrix and a user transformation matrix. The item transformation matrix is multiplied with the item matrix to generate a transformed item embedding matrix. An orthogonal Procrustes transformation is then used to obtain the orthogonal matrix that most closely maps the transformed item embedding matrix to the transformed item embedding matrix generated from the previous training run of the user and item embeddings. The item transformation matrix and the user transformation matrix are then multiplied by the orthogonal Procrustes matrix to generate a final item transformation matrix and a final user transformation matrix. The stabilized item embedding is generated as the product of the item matrix and the final item transformation matrix and the stabilized user embedding is generated as the product of the user matrix and the final user transformation matrix.

At least one technical advantage of the disclosed techniques relative to the prior art is that, with the disclosed techniques, a standardized embedding space for user and item embeddings across each model training run is established. Another technical advantage of the disclosed techniques is that, once a standardized embedding space has been established based on initial training for the embeddings, future embeddings still use the same standardized embedding space. As a result, with the disclosed techniques, each time the embeddings are updated, the downstream applications that rely on the embeddings don't have to be retrained even though the embeddings have been updated, which significantly reduces the computational resources needed to take advantage of updated embeddings in the downstream applications. These technical advantages represent one or more technological improvements over prior art approaches.

### System Overview

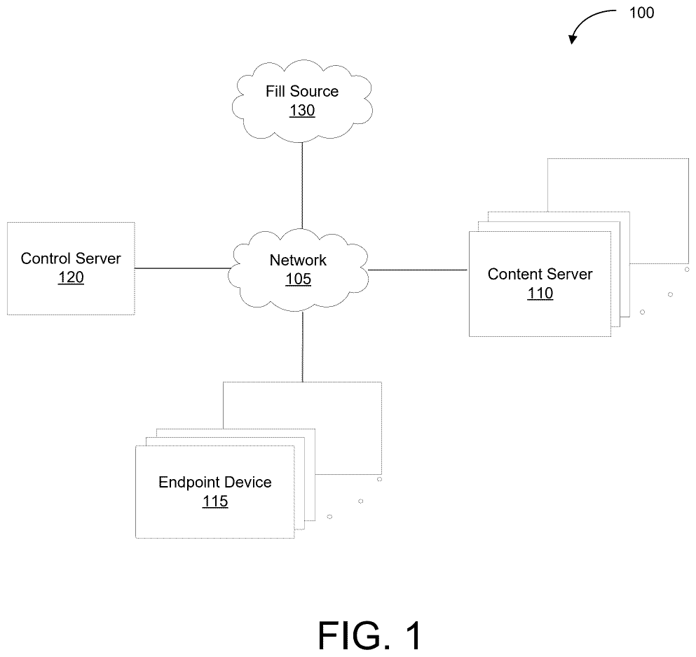

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content servers 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

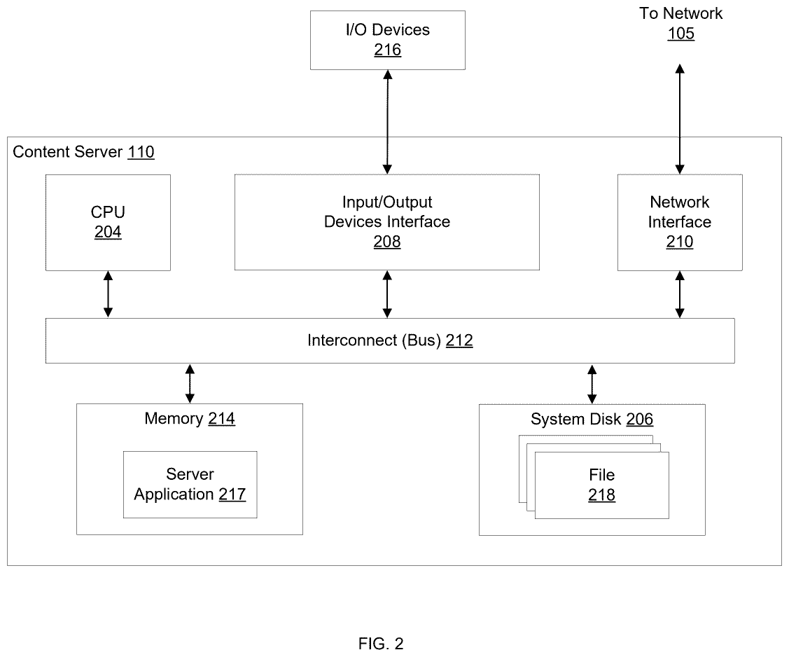

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

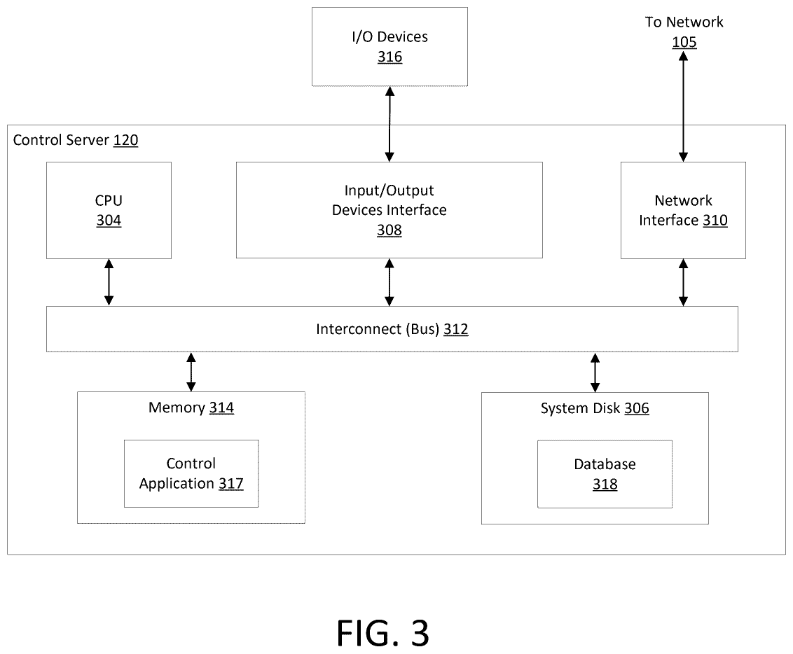

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

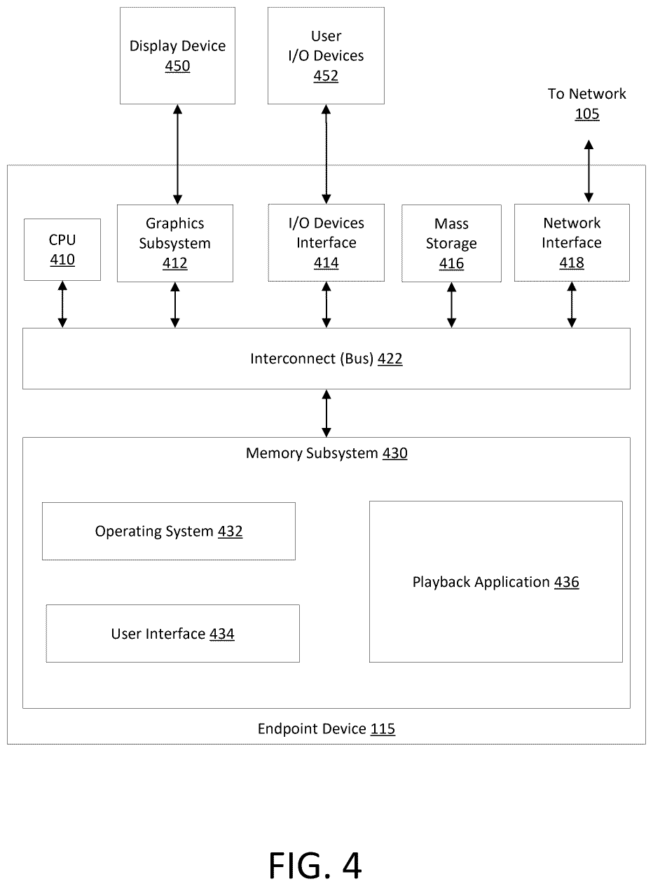

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452.

### Stabilized User Embedding and Stabilized Item Embedding Generation

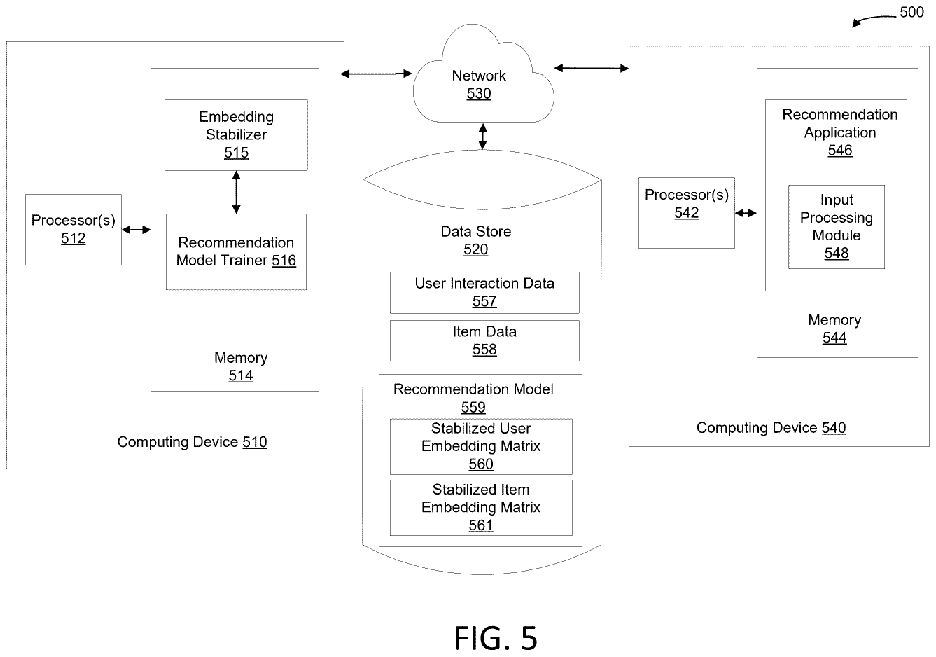

FIG. 5 is a block diagram of a computer-based system 500 according to various embodiments. As shown, the computer-based system 500 includes, without limitation, computing devices 510 and 540, a data store 520, and a network 530. Computing device 510 includes, without limitation, one or more processors 512 and memory 514. Memory 514 includes, without limitation, an embedding stabilizer 515, and a recommendation model trainer 516. Data store 520 includes, without limitation, user interaction data 557, item data 558, and a recommendation model 559.

Recommendation model 559 includes, without limitation, stabilized user embedding matrix 560 and stabilized item embedding matrix 561. Computing device 540 includes, without limitation, one or more processors 542 and memory 544. Memory 544 includes, without limitation, a recommendation application 546. Recommendation application 546 includes, without limitation, an input processing module 548. Although FIG. 5 is described in the context of recommendation systems, it is understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 514 of computing device 510 stores content, such as software applications and data, for use by processor(s) 512. As shown, memory 514 includes, without limitation, an embedding stabilizer 515 and a recommendation model trainer 516. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

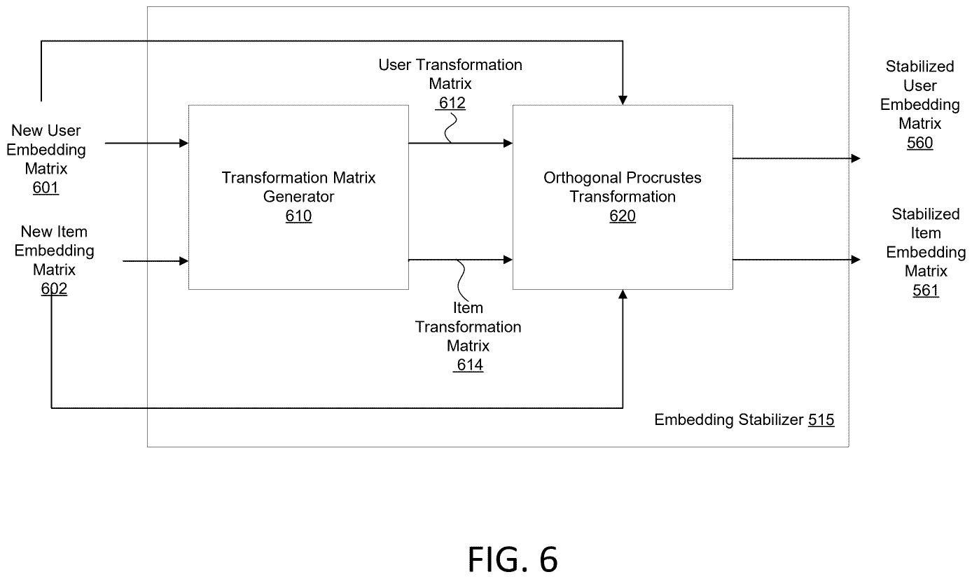

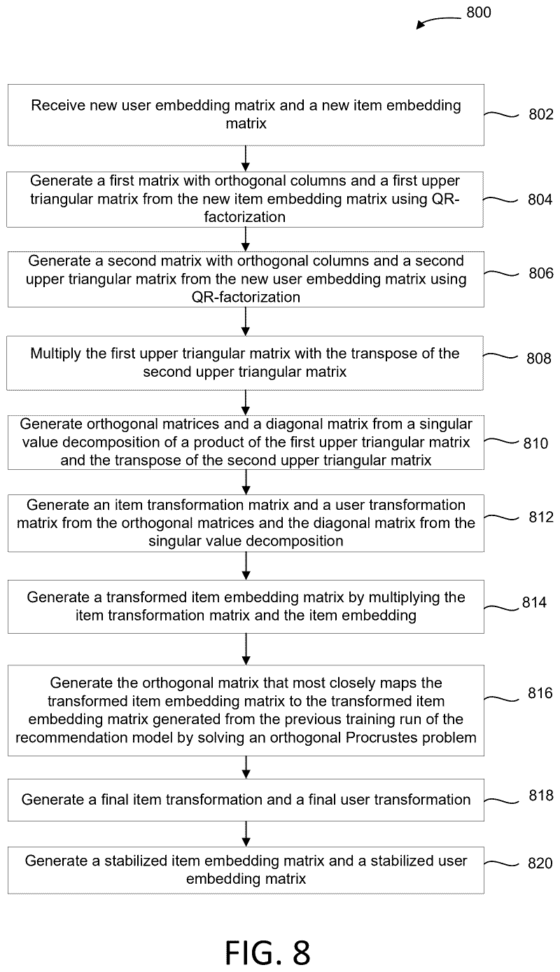

Embedding stabilizer 515 stored within memory 514 is configured to generate stabilized user embedding matrix and stabilized item embedding matrix. Embedding stabilizer 515 generates a first matrix with orthogonal columns and a first upper triangular matrix from a new user embedding matrix using QR-factorization. Next, embedding stabilizer 515 generates a second matrix with orthogonal columns and a second upper triangular matrix from a new item embedding matrix using QR-factorization. A singular value decomposition is performed on the first upper triangular matrix multiplied with the transpose of the second upper triangular matrix to generate the low-rank singular value decomposition for the product of new item embedding matrix 602 and the new user embedding matrix 601. The orthogonal matrices and diagonal matrix resulting from the singular value decomposition are then used to generate an item transformation matrix and a user transformation matrix. The item transformation matrix is multiplied with the item matrix to generate a transformed item embedding. An orthogonal Procrustes transformation is then used to obtain the orthogonal matrix that most closely maps the transformed item embedding to the transformed item embedding from the previous run. The item transformation matrix and the user transformation matrix are then multiplied by the orthogonal Procrustes matrix to generate a final item transformation matrix and a final user transformation matrix. The stabilized item embedding is generated as the product of the new item embedding matrix and the final item transformation matrix and the stabilized user embedding is generated as the product of the new user embedding matrix and the final user transformation matrix. The stabilized item embedding matrix 561 and the stabilized user embedding matrix 561 belong to the same embedding space as the new item embedding matrix and the new user embedding matrix. Embedding stabilizer 515 can be used with any suitable recommendation application, such as recommendation application 546. The operations performed by embedding stabilizer 515 are described in greater detail in conjunction with FIGS. 6 and 8.

Recommendation model trainer 516 trains recommendation model 559 using user interaction data 557 and item data 558. User interaction data 557 includes broad patterns of user behavior and activity across various recommendation tasks, providing insights into what the user engages with, how the user interacts, and the preferences of the user over time. For example, in a video streaming platform, user interaction data 557 can include viewing history, watch time for specific genres, interactions such as pausing or skipping content, and search queries. Additionally, user interaction data 557 includes implicit feedback, such as content that users hover over, actions such as fast-forwarding through content, and/or the like. User interaction data 557 also includes user-content interactions across various tasks, such as query-content recommendation, where the data includes the user's search queries and the corresponding content engagement, content-content recommendation, where interactions between different pieces of content are tracked (e.g., watching related movies or shows), and pre-query tasks, where engagement patterns prior to a search or content request are recorded. In an e-commerce platform, user interaction data 557 can include product views, items added to carts, purchase history, and even browsing behavior, such as time spent on product pages, the frequency of returning to certain categories, and/or the like. In a social media platform, user interaction data 557 can include likes, shares, comments, and profile visits. Item data 558 includes data related to various recommendation tasks, such as query-content recommendation, content-content recommendation, pre-query tasks, and/or the like. For example, in a query-content recommendation task, item data 558 could include the user's specific search queries, the results returned in terms of entity identifier, and the corresponding user engagement with the returned content. In content-content recommendation tasks, item data 558 could include interactions between related content items (e.g., watching a movie and then engaging with the movie sequels or related genres). In pre-query tasks, item data 558 could capture user behaviors prior to initiating a search, such as browsing activity or hovering over content items without directly engaging. Item data 558 also includes other contextual details, such as the type of query (e.g., keyword search or voice command), the UI page from which the query originates (e.g., homepage or genre-specific page), and/or the like. In some embodiments, recommendation model trainer 516 uses stochastic gradient descent (SGD) techniques to minimize task-specific loss functions, such as cross entropy loss and/or the like. In various embodiments, recommendation model trainer 516 evaluates recommendation model 559 during training using various ranking metrics, such as Normalized Mean Reciprocal Rank (NMRR) and Normalized Discounted Cumulative Gain (NDCG), which measure the quality of the generated recommendations. In some embodiments, recommendation model trainer 516 uses cross-validation techniques along with early stopping to avoid overfitting. Additionally, recommendation model trainer 516 uses regularization techniques such as dropout, L1 or L2 regularization, and batch normalization for more robustness.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing, without limitation, user interaction data 557, item data 558, and recommendation model 559.

Recommendation model 559 is a machine learning model, which includes stabilized user embedding matrix 560 and stabilized item embedding matrix 561, and processes user inputs and item inputs generating recommendations. Stabilized user embedding matrix 560 is a matrix where each row is a vector representation of user features that capture the underlying patterns of the user's preferences and habits in a low-dimensional space. User features include various user-content interaction data that represent a user's preferences and behaviors on the recommendation platform. User features can include explicit user interactions, such as a user's viewing history, search queries, content likes or ratings, and purchase history, as well as implicit user actions, such time spent on certain content, scrolling behavior, click patterns, and/or the like. In various embodiments, stabilized user embedding matrix 560 can be generated through offline batch processing, an event-triggered approach, or by live/online inference.

Stabilized item embedding matrix 561 is a matrix where each row is a vector representation of item features, encoding the user's immediate environment in a low-dimensional space. Item features include various real-time and situational features specific to the task being performed, providing information about the environment in which a recommendation is made. Item features can include explicit contextual data, such as the user's current query, the content or item the user is interacting with, device type, location, time of day, and/or the like, as well as implicit signals, such as session duration, network conditions, recent activity patterns, and/or the like. For example, item features could vary based on the task: in a query-content recommendation task, the item features could include the specific query and relevant metadata; in a content-content recommendation task, the item features could include recently watched content and content similarity; and in a pre-query task, item features could include prior interactions or searches leading up to the current session.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and item inputs from input devices (not shown), such as a keyboard or a mouse.

Memory 544 of computing device 540 stores content, such as software applications and data, for use by processor(s) 542. As shown, memory 544 includes, without limitation, a recommendation application 546. Memory 544 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

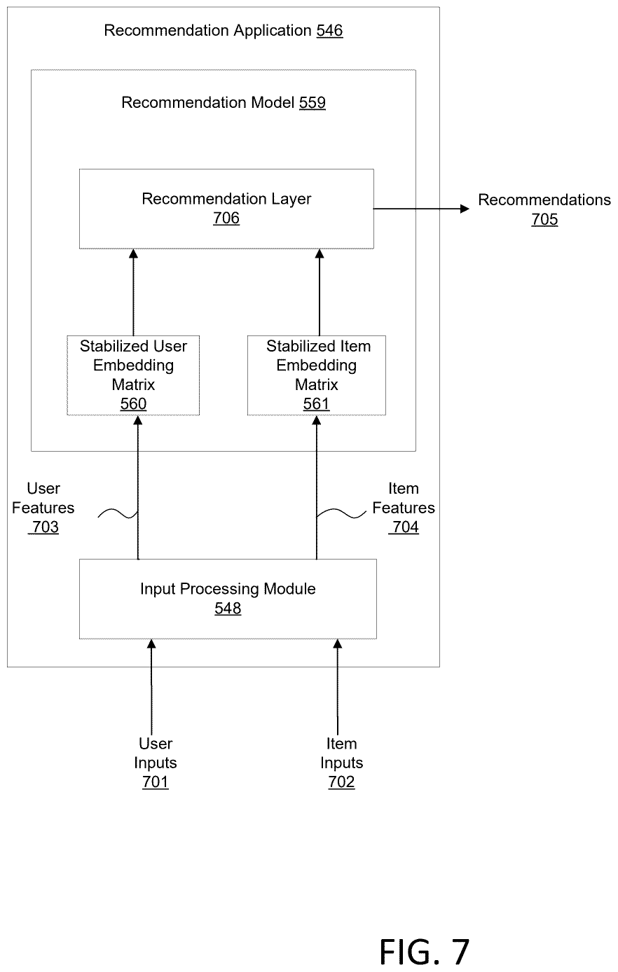

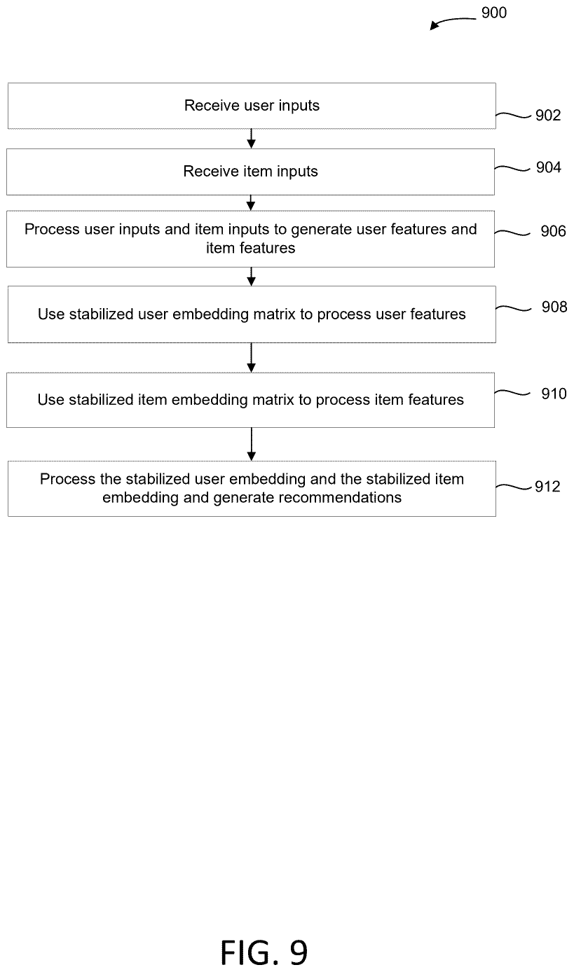

Recommendation application 546 processes user inputs and item inputs and generates recommendations. As shown, recommendation application 546 includes, without limitation, input processing module 548. User inputs include, without limitation, real-time interactions, such as clicks, searches, likes, plays, and other immediate user activities on the platform. In some embodiments, item inputs are related to the specific task at hand and provide additional information about the user's environment and session. Item inputs can vary based on the nature of the recommendation task, including but not limited to device type, time of day, session length, and the specific content or product currently being interacted with. For example, in a query-content recommendation task, item inputs could include the user's search query, location, and the time of day, whereas in a content-content recommendation task, the item could focus more on recent user interactions, content history, or content similarity. In pre-query tasks, item inputs such as the user's browsing behavior or past searches. In various embodiments, recommendation application 546 receives user inputs through various I/O devices (not shown), including direct interactions, browsing activity, and implicit feedback, such as engagement duration, skipped items, and/or the like. Item inputs are captured through various channels, such as clickstream data, which tracks each user clicks and tracking scripts (e.g. JavaScript or similar technologies embedded in the recommendation platform), which record user page navigation or hovering over content. On the backend, server logs can capture item inputs by logging user requests, including search queries, page loads, and API calls. In some embodiments, by dynamically analyzing and processing the real-time user inputs and item inputs, recommendation application 546 ensures that the generated recommendations are relevant and personalized to the user's ongoing behavior and task context. Recommendation application 546 is described in more detail in conjunction with FIGS. 7 and 9.

Input processing module 548 processes user inputs and item inputs to generate user features and item features. Input processing module 548 receives raw data from various user inputs and item inputs and processes the data into a structured format suitable for use by the trained recommendation model 559. The processing includes, without limitation, handling missing or inconsistent data, normalizing numerical values (e.g., session length, interaction frequency), and encoding categorical variables (e.g., content genres, product types) into formats that can be used by the trained recommendation model 559. In some embodiments, input processing module 548 performs pre-processing tasks, such as feature scaling or standardization.

FIG. 6 is a more detailed illustration of embedding stabilizer 515 of FIG. 5, according to various embodiments. As shown, embedding stabilizer 515 includes, without limitation, a transformation matrix generator 610, a user transformation matrix 612, an item transformation matrix 614, and an orthogonal Procrustes transformation 620. Embedding stabilizer 515 receives new user embedding matrix 601 and new item embedding matrix 602 and generates stabilized user embedding matrix 560 and stabilized item embedding matrix 561.

Transformation matrix generator 610 receives new user embedding matrix 601 and new item embedding matrix 602 from data store 520 (not shown). New user embedding matrix 601 and new item embedding matrix 602 are generated from the kth training run of a retrained model. In various embodiments, the retrained model can be recommendation model 559. In various embodiments, new user embedding matrix 601 and new item embedding matrix 602 include new user and new item data but may exist in a different embedding space than the user embeddings and item embeddings from the previous training run. Transformation matrix generator 610 generates a matrix with orthogonal columns, Q_{Tk}, and an upper triangular matrix, R_{Tk}, from new item embedding matrix 602 using QR-factorization according to equation (1):

Tₖ=Q_{Tk}R_{Tk} (1)

where Tₖ is a matrix of new item embeddings with embedding dimension e.

Transformation matrix generator 610 generates a matrix with orthogonal columns Q_{Wk} and an upper triangular matrix R_{Wk} from new user embedding matrix 601 using QR-factorization according to equation (2):

Wₖ=Q_{Wk}R_{Wk} (2)

where Wₖ is a matrix of new user embeddings with embedding dimension e. Next, transformation matrix generator 610 multiplies the first upper triangular matrix, R_{Tk} with the transpose of the second upper triangular matrix,

$${R}_{Wk}^{T} ,$$

then transformation matrix generator 610 generates orthogonal matrices and a diagonal matrix from a singular value decomposition on

$${R}_{Tk} {R}_{Wk}^{T}$$

according to equation (3):

$${R}_{Tk} {R}_{Wk}^{T} = {U}_{Rk} {S}_{k} {V}_{Rk}^{T} \qquad ( 3 )$$

where U_{Rk}, V_{Rk} are orthogonal matrices and Sₖ is a diagonal matrix. Transformation matrix generator 610 generates user transformation matrix 612, M_{Wk}, from the orthogonal matrix U_{Rk} and the diagonal matrix Sₖ according to equation (4):

$${M}_{Wk} = {R}_{Tk}^{T} {U}_{Rk} {S}_{k}^{- \frac{1}{{2}^{}}} \qquad ( 4 )$$

and generates item transformation matrix 614 from the orthogonal matrix V_{Rk} and the diagonal matrix Sₖ according to equation (5):

$${M}_{Tk} = {R}_{Wk}^{T} {V}_{Rk} {S}_{k}^{- \frac{1}{{2}^{}}} \qquad ( 5 )$$

User transformation matrix 612 satisfies equation (6):

$${W}_{k} {M}_{Wk} = {V}_{k} {S}_{k}^{\frac{1}{{2}^{}}} \qquad ( 6 )$$

where Vₖ is and orthogonal matrix such that Vₖ=Q_{Wk}V_{Rk}. Item transformation matrix satisfies equation (7):

$${T}_{k} {M}_{Tk} = {U}_{k} {S}_{k}^{\frac{1}{{2}^{}}} \qquad ( 7 )$$

where Uₖ is an orthogonal matrix such that Uₖ=Q_{Tk}U_{Rk}. User transformation matrix 612 and item transformation matrix 614 and equations (6) and (7) yield a standardized, non-degenerate factorization of the embedding space given according to equation (8):

$${T}_{k} {M}_{Tk} ( {W}_{k} {M}_{Wk}^{T} ) = {U}_{k} {S}_{k} {V}_{k}^{T} = {T}_{k} {W}_{k}^{T} \qquad ( 8 )$$

Transformation matrix generator then passes user transformation matrix 612 and item transformation matrix 614 to orthogonal Procrustes transformation 620.

Orthogonal Procrustes transformation 620 receives new user embedding matrix 601, new item embedding matrix 602 and user transformation matrix 612 and item transformation matrix 614 from transformation matrix generator 610. First, orthogonal Procrustes transformation 620 generates a transformed item embedding matrix, Tₖ′, by multiplying the item transformation matrix 614 and new item embedding matrix 602 according to equation (9):

$${T}_{k}^{′} = {T}_{k} {M}_{Tk} \qquad ( 9 )$$

Orthogonal Procrustes transformation 620 then generates an orthogonal matrix, Rₖ, that most closely maps the transformed item embedding matrix,

$${T}_{k}^{′} ,$$

to the transformed item embedding matrix generated from the previous training run,

$${T}_{k - 1}^{′} .$$

To generate the orthogonal matrix, Rₖ, Orthogonal Procrustes transformation 620 solves the optimization problem given by equation (10):

$${min}_{R} {‖ RA - B ‖}_{F} \qquad ( 10 )$$

where R is an orthogonal matrix, A, B are given matrices, and ∥⋅∥_{F} denotes the Frobenius norm. Orthogonal Procrustes transformation 620 generates a final item transformation,

$${M}_{Tk}^{′} ,$$

and a final user transformation,

$${M}_{Wk}^{′}$$

according to equation (11) and (12):

$${M}_{Tk}^{′} = {M}_{Tk} {R}_{k} \qquad ( 11 )$$

$${M}_{Wk}^{′} = {M}_{Wk} {R}_{k} \qquad ( 12 )$$

Orthogonal Procrustes transformation 620 uses the final user embedding and final item embedding to generate stabilized user embedding matrix 560 and stabilized item embedding matrix 561 according to equations (13) and (14):

$$\text{?} = {W}_{k} {M}_{Wk}^{′} \qquad ( 13 )$$

$$\text{?} = {T}_{k} {M}_{Tk}^{′} \qquad ( 14 )$$

As stabilized user embedding matrix 560 and stabilized item embedding matrix 561 preserve the product given according to equation (15):

$$\text{?} = {{T}_{k} ( {W}_{k} )}^{T} \qquad ( 15 )$$

Stabilized user embedding matrix 560 and stabilized item embedding matrix 602 are in the same embedding space new user embedding matrix 601 and new item embedding matrix 602.

### Personalized Recommendations Using the Recommendation Model

FIG. 7 is a more detailed illustration of the recommendation application 546, according to various embodiments. Recommendation application 546 uses the trained recommendation model 559 to process user inputs 701 and item inputs 702 and generates recommendations 705. As shown, recommendation application 546 includes, without limitation, recommendation model 559 and input processing module 548. Recommendation model 559 includes, without limitation, stabilized user embedding matrix 560, stabilized item embedding matrix 561, and a recommendation layer 706.

Input processing module 548 processes user inputs 701 and item inputs 702 and generates user features 703 and item features 704. In some embodiments, the processing includes normalizing numerical values (e.g., converting session duration into a consistent format), and/or the like. For example, normalizing numerical values could include converting varying time-based inputs, such as session duration or time spent on specific content, into a consistent format (e.g., minutes or seconds). In addition to normalization, input processing module 548 encodes categorical variables, transforming inputs such as device type (e.g., mobile, desktop, or tablet), content genres (e.g., drama, action, comedy), and page identifiers (e.g., homepage, genre page, search results page) into numerical representations. In at least one embodiment, input processing module 548 applies feature scaling to numerical user inputs 701, such as interaction frequency (e.g., the number of clicks a user has made on similar content), ensuring that all numerical values are scaled to a consistent range, typically between 0 and 1, to prevent some values from disproportionately influencing the predictions of the trained recommendation model 559.

Recommendation model 559 processes user features 703 and item features 704 and generates recommendations 705. For example, recommendation 705 can be a probability score for positive engagement with content. Stabilized user embedding matrix 560 included in recommendation model 559 processes user features 703. Stabilized item embedding matrix 561 included in recommendation model 559 processes item features 704. Stabilized user embedding matrix 560 and stabilized item embedding matrix 561 are then passed to recommendation layer 706.

Recommendation layer 706 processes stabilized user embedding matrix 560 and stabilized item embedding matrix 561 and generates recommendations 705. In various embodiments, recommendation layer 706 calculates the product of stabilized item embedding matrix 561 and the transpose of stabilized user embedding matrix 560, [symbol] In various embodiments, recommendation 705 of an item i for a given user j is given by [symbol] where [symbol] is the row of [symbol] corresponding to item i and (w_{j,k})^{T} is the column of [symbol] corresponding to user j.

### Generating Stabilized User Embeddings and Stabilized Item Embeddings

FIG. 8 is a flow diagram of method steps for generating stabilized item embeddings and stabilized user embeddings, according to various embodiments. Although the method steps are described in conjunction with the embodiments of FIGS. 1-7, persons skilled in the art will understand that any system configured to perform the method steps, in any order, falls within the scope of the various embodiments.

As shown, a method 800 begins at step 802, where embedding stabilizer 515 receives new user embedding matrix 601 and new item embedding matrix 602 New user embedding matrix 601 is a matrix where each row is a vector representation generated from user features that capture the underlying patterns of the user's preferences and habits in a low-dimensional space. New item embedding matrix 602 is a matrix where each row is a vector representation generated from the item features, encoding the user's immediate environment in a low-dimensional space.

At step 804, transformation matrix generator 610 generates a first matrix with orthogonal columns and a first upper triangular matrix from new item embedding matrix 602 using QR-factorization. More specifically, transformation matrix generator receives new item embedding matrix 602 and generates a first matrix with orthogonal columns and a first upper triangular matrix from the new item embedding matrix 602 using QR-factorization according to equation (1).

At step 806, transformation matrix generator 610 generates a second matrix with orthogonal columns and a second upper triangular matrix from new user embedding matrix 601 using QR-factorization. More specifically, transformation matrix generator receives new user embedding matrix 601 and generates a second matrix with orthogonal columns and a second upper triangular matrix from the new user embedding matrix 602 using QR-factorization according to equation (2).

At step 808, transformation matrix generator 610 multiplies the first upper triangular matrix with the transpose of the second upper triangular matrix.

At step 810, transformation matrix generator 610 generates orthogonal matrices and a diagonal matrix from a singular value decomposition of a product of the first upper triangular matrix and a transpose of the second upper triangular matrix. More specifically, transformation matrix generator 610 generates orthogonal matrices and a diagonal matrix from a singular value decomposition of a product of the first upper triangular matrix and the transpose of the second upper triangular matrix according to equation (3).

At step 812, transformation matrix generator 610 generates an item transformation matrix and a user transformation matrix from the orthogonal matrices and the diagonal matrix from the singular value decomposition. More specifically, transformation matrix generator 610 generates user transformation matrix 612 from the orthogonal matrix and the diagonal matrix from the singular value decomposition according to equation (4). Transformation matrix generator 610 generates item transformation matrix 614 from the orthogonal matrix and the diagonal matrix from the singular value decomposition according to equation (5).

At step 814, orthogonal Procrustes transformation 620 generates a transformed item embedding matrix by multiplying the item transformation matrix 614 and the new item embedding matrix 602. More specifically, orthogonal Procrustes transformation 620 generates a transformed item embedding matrix by multiplying the item transformation matrix 614 and the new item embedding matrix according to equation (9).

At step 816, orthogonal Procrustes transformation 620 generates the orthogonal matrix that most closely maps the transformed item embedding matrix to the transformed item embedding matrix generated from the previous training run by solving an orthogonal Procrustes problem.

At step 818, orthogonal Procrustes transformation 620 generates a final item transformation and a final user transformation. More specifically, orthogonal Procrustes transformation 620 generates a final item transformation according to equation (11) and a final user transformation according to equation (12).

At step 820, orthogonal Procrustes transformation 620 generates a stabilized item embedding matrix 561 and a stabilized user embedding matrix 560. Orthogonal Procrustes transformation 620 uses the final user embedding to generate stabilized user embedding matrix 560 according to equation (13). Orthogonal Procrustes transformation 620 uses the final item embedding to generate stabilized item embedding matrix 561 according to equation (14).

### Generating Personalized Recommendations

FIG. 9 sets forth a flow diagram of method steps for generating recommendations 705, according to various embodiments. Although the method steps are described in conjunction with the embodiments of FIGS. 1-7, persons skilled in the art will understand that any system configured to perform the method steps, in any order, falls within the scope of the various embodiments.

A method 900 begins with step 902, where recommendation application 546 receives user inputs 701. In various embodiments, recommendation application 546 receives user inputs 701 through various input channels, including real-time interactions such as clicks, searches, likes, plays, and other immediate user activities on the recommendation platform. Additionally, user inputs 701 can be received as the user interacts with different content and/or performs actions within the recommendation platform's user interface. In some embodiments, recommendation application 546 receives user inputs 701 via voice commands, typed queries, and/or the like. In at least one embodiment, recommendation application 546 receives implicit user inputs 701, such as engagement duration, scrolling behavior, and/or skipped content.

At step 904, recommendation application receives item inputs 702. In some embodiments, item inputs 702 are related to the specific task at hand and provide additional information about the user's environment and session. Item inputs can vary based on the nature of the recommendation task, including but not limited to device type, time of day, session length, and the specific content or product currently being interacted with.

At step 906, input processing module 548 processes user inputs 701 and item inputs 702 and generates user features 703 and item features 704. In various embodiments, input processing module 548 processes user inputs 701 and item inputs 702 by normalizing numerical values and encoding categorical variables to ensure consistency in the data. In some embodiments, input processing module 548 applies transformations, such as feature scaling to ensure that numerical values are within a consistent range. Additionally, input processing module 548 encodes categorical data into numerical representations.

At step 908, recommendation model 559 uses stabilized user embedding matrix 560 to process user features 703. Stabilized user embedding matrix 560 is a matrix where each row is a vector representation of user features that capture the underlying patterns of the user's preferences and habits in a low-dimensional space. Stabilized user embedding matrix 560 is in the same embedding space as the user embeddings from the previous training runs.

At step 910, recommendation model 559 uses stabilized item embedding matrix 561 to process item features 704. Stabilized item embedding matrix 561 is a matrix where each row is a vector representation of the item features, encoding the user's immediate environment in a low-dimensional space. Stabilized item embedding matrix 561 is in the same embedding space as the user embeddings from the previous training runs.

At step 912, recommendation model 559 processes the stabilized user embedding matrix 560 and the stabilized item embedding matrix 561 and generates recommendation 705. In various embodiments, an recommendation layer 706 processes stabilized user embedding matrix 560 and stabilized item embedding matrix 561 and generates recommendations 705. In various embodiments, recommendation layer 706 calculates the product of stabilized user embedding matrix 560 and stabilized item embedding matrix 561.

In sum, a stabilized item embedding matrix and a stabilized user embedding matrix are generated using an orthogonal low rank transformation. First, a user-item interaction matrix is approximated by the product of an item embedding matrix and a user embedding matrix. Next, a first matrix with orthogonal columns and a first upper triangular matrix is generated from the item embedding matrix using QR-decomposition. Then, a second matrix with orthogonal columns and a second upper triangular matrix is generated from the user embedding matrix using QR-factorization. A singular value decomposition is performed on the first upper triangular matrix multiplied with the transpose of the second upper triangular matrix to generate the low-rank singular value decomposition for the product of the item matrix and the user matrix. The orthogonal matrices and diagonal matrix resulting from the singular value decomposition are then used to generate an item transformation matrix and a user transformation matrix. The item transformation matrix is multiplied with the item matrix to generate a transformed item embedding matrix. An orthogonal Procrustes transformation is then used to obtain the orthogonal matrix that most closely maps the transformed item embedding matrix to the transformed item embedding matrix generated from the previous training run of the user and item embeddings. The item transformation matrix and the user transformation matrix are then multiplied by the orthogonal Procrustes matrix to generate a final item transformation matrix and a final user transformation matrix. The stabilized item embedding is generated as the product of the item matrix and the final item transformation matrix and the stabilized user embedding is generated as the product of the user matrix and the final user transformation matrix.

At least one technical advantage of the disclosed techniques relative to the prior art is that, with the disclosed techniques, a standardized embedding space for user and item embeddings across each model training run is established. Another technical advantage of the disclosed techniques is that, once a standardized embedding space has been established based on initial training for the embeddings, future embeddings still use the same standardized embedding space. As a result, with the disclosed techniques, each time the embeddings are updated, the downstream applications that rely on the embeddings don't have to be retrained even though the embeddings have been updated, which significantly reduces the computational resources needed to take advantage of updated embeddings in the downstream applications. These technical advantages represent one or more technological improvements over prior art approaches.

Aspects of the subject matter described herein are set out in the following numbered clauses.

1. In some embodiments, a computer-implemented method for stabilizing embeddings, the computer-implemented method comprises receiving a new user embedding matrix, receiving a new item embedding matrix, generating a transformed user embedding matrix and a transformed item embedding matrix from the new user embedding matrix and the new item embedding matrix, generating a transformation that maps the transformed item embedding matrix to an embedding space of a previous version of the item embedding matrix, generating a stabilized user embedding matrix based on the transformation, the new user embedding matrix, and the transformed user embedding matrix, and generating a stabilized item embedding matrix based on the transformation, the new item embedding matrix, and the transformed item embedding matrix.

2. The computer-implemented method of clause 1, wherein generating the transformed user embedding matrix and the transformed item embedding matrix from the new user embedding matrix and the new item embedding matrix comprises generating a first matrix with orthogonal columns and a first upper triangular matrix from the new item embedding matrix, generating a second matrix with orthogonal columns and a second upper triangular matrix from the new user embedding matrix, generating orthogonal matrices and a diagonal matrix from a product of the first upper triangular matrix and a transpose of the second upper triangular matrix, generating an item transformation matrix and a user transformation matrix from the orthogonal matrices and the diagonal matrix, and generating the transformed item embedding matrix by multiplying the item transformation matrix and the new item embedding matrix.

3. The computer-implemented method of clauses 1 or 2, wherein generating the first matrix with orthogonal columns and the first upper triangular matrix from the new item embedding matrix comprises performing a QR-decomposition.

4. The computer-implemented method of any of clauses 1-3, wherein generating the second matrix with orthogonal columns and the second upper triangular matrix from new user embedding matrix comprises performing a QR-decomposition.

5. The computer-implemented method of any of clauses 1-4, wherein generating the orthogonal matrices and the diagonal matrix comprises performing a singular value decomposition of the product of the first upper triangular matrix and a transpose of the second upper triangular matrix.

6. The computer-implemented method of any of clauses 1-5, wherein generating the transformation comprises generating an orthogonal matrix that most closely maps the transformed item embedding matrix to the transformed item embedding matrix.

7. The computer-implemented method of any of clauses 1-6, wherein generating the orthogonal matrix comprises solving an orthogonal Procrustes problem.

8. The computer-implemented method of any of clauses 1-7, wherein the previous version of the user embedding matrix is generated from a previous training run of a machine learning model that included the previous version of the user embedding matrix.

9. The computer-implemented method of any of clauses 1-8, wherein a recommendation model generates a recommendation using the stabilized user embedding matrix and the stabilized item embedding matrix.

10. The computer-implemented method of any of clauses 1-9, wherein generating the recommendation using the recommendation model comprises receiving one or more user inputs, receiving one or more item inputs, determining one or more user features based on the one or more user inputs, determining one or more item features based on the one or more item inputs, using the stabilized user embedding matrix to generate user embeddings from the user features, using the stabilized item embedding matrix to generate item embeddings from the item features, and processing the user embeddings and the item embeddings using a recommendation layer to generate the recommendation.

11. The computer-implemented method of any of clauses 1-10, wherein the stabilized user embedding matrix is a matrix where each row includes a low-dimensional vector representation of a user feature, and the stabilized item embedding matrix is a matrix where each row includes a low-dimensional vector representation of an item feature.

12. In some embodiments, a non-transitory computer-readable medium stores instructions that, when executed by one or more processors, cause the one or more processors to perform a method for stabilizing embeddings comprises receiving a new user embedding matrix, receiving a new item embedding matrix, generating a transformed user embedding matrix and a transformed item embedding matrix from the new user embedding matrix and the new item embedding matrix, generating a transformation that maps the transformed item embedding matrix to an embedding space of a previous version of the item embedding matrix, generating a stabilized user embedding matrix based on the transformation, the new user embedding matrix, and the transformed user embedding matrix, and generating a stabilized item embedding matrix based on the transformation, the new item embedding matrix, and the transformed item embedding matrix.

13. The non-transitory computer-readable medium of clause 12, wherein generating the transformed user embedding matrix and the transformed item embedding matrix from the new user embedding matrix and the new item embedding matrix comprises generating a first matrix with orthogonal columns and a first upper triangular matrix from the new item embedding matrix, generating a second matrix with orthogonal columns and a second upper triangular matrix from the new user embedding matrix, generating orthogonal matrices and a diagonal matrix from a product of the first upper triangular matrix and a transpose of the second upper triangular matrix, generating an item transformation matrix and a user transformation matrix from the orthogonal matrices and the diagonal matrix, and generating the transformed item embedding matrix by multiplying the item transformation matrix and the new item embedding matrix.

14. The non-transitory computer-readable medium of clauses 12 or 13, wherein generating the first matrix with orthogonal columns and the first upper triangular matrix from the new item embedding matrix comprises performing a QR-decomposition.

15. The non-transitory computer-readable medium of any of clauses 12-14, wherein generating the second matrix with orthogonal columns and the second upper triangular matrix from new user embedding matrix comprises performing a QR-decomposition.

16. The non-transitory computer-readable medium of any of clauses 12-15, wherein generating the orthogonal matrices and the diagonal matrix comprises performing a singular value decomposition of the product of the first upper triangular matrix and a transpose of the second upper triangular matrix.

17. The non-transitory computer-readable medium of any of clauses 12-16, wherein generating the transformation comprises generating an orthogonal matrix that most closely maps the transformed item embedding matrix to the transformed item embedding matrix.

18. The non-transitory computer-readable medium of any of clauses 12-17, wherein generating the orthogonal matrix comprises solving an orthogonal Procrustes problem.

19. The non-transitory computer-readable medium of any of clauses 12-18, wherein the previous version of the user embedding matrix is generated from a previous training run of a machine learning model that included the previous version of the user embedding matrix.

20. In some embodiments, a system comprises one or more memories storing instructions, and one or more processors that are coupled to the one or more memories and, when executing the instructions, are configured to receive a new user embedding matrix, receive a new item embedding matrix, generate a transformed user embedding matrix and a transformed item embedding matrix from the new user embedding matrix and the new item embedding matrix, generate a transformation that maps the transformed item embedding matrix to an embedding space of a previous version of the item embedding matrix, generate a stabilized user embedding matrix based on the transformation, the new user embedding matrix, and the transformed user embedding matrix, and generate a stabilized item embedding matrix based on the transformation, the new item embedding matrix, and the transformed item embedding matrix.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for stabilizing embeddings, the computer-implemented method comprising:
receiving a new user embedding matrix;
receiving a new item embedding matrix;
generating a transformed user embedding matrix and a transformed item embedding matrix from the new user embedding matrix and the new item embedding matrix;
generating a transformation that maps the transformed item embedding matrix to an embedding space of a previous version of the item embedding matrix;
generating a stabilized user embedding matrix based on the transformation, the new user embedding matrix, and the transformed user embedding matrix; and
generating a stabilized item embedding matrix based on the transformation, the new item embedding matrix, and the transformed item embedding matrix.

2. The computer-implemented method of claim 1, wherein generating the transformed user embedding matrix and the transformed item embedding matrix from the new user embedding matrix and the new item embedding matrix comprises:
generating a first matrix with orthogonal columns and a first upper triangular matrix from the new item embedding matrix;
generating a second matrix with orthogonal columns and a second upper triangular matrix from the new user embedding matrix;
generating orthogonal matrices and a diagonal matrix from a product of the first upper triangular matrix and a transpose of the second upper triangular matrix;
generating an item transformation matrix and a user transformation matrix from the orthogonal matrices and the diagonal matrix; and
generating the transformed item embedding matrix by multiplying the item transformation matrix and the new item embedding matrix.

3. The computer-implemented method of claim 2, wherein generating the first matrix with orthogonal columns and the first upper triangular matrix from the new item embedding matrix comprises performing a QR-decomposition.

4. The computer-implemented method of claim 2, wherein generating the second matrix with orthogonal columns and the second upper triangular matrix from new user embedding matrix comprises performing a QR-decomposition.

5. The computer-implemented method of claim 2, wherein generating the orthogonal matrices and the diagonal matrix comprises performing a singular value decomposition of the product of the first upper triangular matrix and a transpose of the second upper triangular matrix.

6. The computer-implemented method of claim 1, wherein:
generating the transformation comprises generating an orthogonal matrix that most closely maps the transformed item embedding matrix to the transformed item embedding matrix.

7. The computer-implemented method of claim 6, wherein generating the orthogonal matrix comprises solving an orthogonal Procrustes problem.

8. The computer-implemented method of claim 1, wherein the previous version of the user embedding matrix is generated from a previous training run of a machine learning model that included the previous version of the user embedding matrix.

9. The computer-implemented method of claim 1, wherein a recommendation model generates a recommendation using the stabilized user embedding matrix and the stabilized item embedding matrix.

10. The computer-implemented method of claim 9, wherein generating the recommendation using the recommendation model comprises:
receiving one or more user inputs;
receiving one or more item inputs;
determining one or more user features based on the one or more user inputs;
determining one or more item features based on the one or more item inputs;
using the stabilized user embedding matrix to generate user embeddings from the user features;
using the stabilized item embedding matrix to generate item embeddings from the item features; and
processing the user embeddings and the item embeddings using a recommendation layer to generate the recommendation.

11. The computer-implemented method of claim 1, wherein:
the stabilized user embedding matrix is a matrix where each row includes a low-dimensional vector representation of a user feature; and
the stabilized item embedding matrix is a matrix where each row includes a low-dimensional vector representation of an item feature.

12. A non-transitory computer-readable medium storing instructions that, when executed by one or more processors, cause the one or more processors to perform a method for stabilizing embeddings, the method comprising:
receiving a new user embedding matrix;
receiving a new item embedding matrix;
generating a transformed user embedding matrix and a transformed item embedding matrix from the new user embedding matrix and the new item embedding matrix;
generating a transformation that maps the transformed item embedding matrix to an embedding space of a previous version of the item embedding matrix;
generating a stabilized user embedding matrix based on the transformation, the new user embedding matrix, and the transformed user embedding matrix; and
generating a stabilized item embedding matrix based on the transformation, the new item embedding matrix, and the transformed item embedding matrix.

13. The non-transitory computer-readable medium of claim 12, wherein generating the transformed user embedding matrix and the transformed item embedding matrix from the new user embedding matrix and the new item embedding matrix comprises:
generating a first matrix with orthogonal columns and a first upper triangular matrix from the new item embedding matrix;
generating a second matrix with orthogonal columns and a second upper triangular matrix from the new user embedding matrix;
generating orthogonal matrices and a diagonal matrix from a product of the first upper triangular matrix and a transpose of the second upper triangular matrix;
generating an item transformation matrix and a user transformation matrix from the orthogonal matrices and the diagonal matrix; and
generating the transformed item embedding matrix by multiplying the item transformation matrix and the new item embedding matrix.

14. The non-transitory computer-readable medium of claim 13, wherein generating the first matrix with orthogonal columns and the first upper triangular matrix from the new item embedding matrix comprises performing a QR-decomposition.

15. The non-transitory computer-readable medium of claim 13, wherein generating the second matrix with orthogonal columns and the second upper triangular matrix from new user embedding matrix comprises performing a QR-decomposition.

16. The non-transitory computer-readable medium of claim 13, wherein generating the orthogonal matrices and the diagonal matrix comprises performing a singular value decomposition of the product of the first upper triangular matrix and a transpose of the second upper triangular matrix.

17. The non-transitory computer-readable medium of claim 12, wherein:
generating the transformation comprises generating an orthogonal matrix that most closely maps the transformed item embedding matrix to the transformed item embedding matrix.

18. The non-transitory computer-readable medium of claim 17, wherein generating the orthogonal matrix comprises solving an orthogonal Procrustes problem.

19. The non-transitory computer-readable medium of claim 12, wherein the previous version of the user embedding matrix is generated from a previous training run of a machine learning model that included the previous version of the user embedding matrix.

20. A system comprising:
one or more memories storing instructions; and
one or more processors that are coupled to the one or more memories and, when executing the instructions, are configured to:
receive a new user embedding matrix;
receive a new item embedding matrix;
generate a transformed user embedding matrix and a transformed item embedding matrix from the new user embedding matrix and the new item embedding matrix;
generate a transformation that maps the transformed item embedding matrix to an embedding space of a previous version of the item embedding matrix;
generate a stabilized user embedding matrix based on the transformation, the new user embedding matrix, and the transformed user embedding matrix; and
generate a stabilized item embedding matrix based on the transformation, the new item embedding matrix, and the transformed item embedding matrix.
